(19) United States
(12) Patent Application Publication
(10) Pub. No.: US 2026/0327813 A1
(43) Pub. Date: Oct. 22, 2026

(54) METHOD FOR INTENSIFIED CARBON DIOXIDE CO-ELECTROLYSIS

(71) Applicant: Chevron U.S.A. Inc., San Ramon, CA (US)

(72) Inventors: Luis Alejandro DIAZ ALDANA, Reno, NV (US); Maria Magdalena RAMIREZ CORREDORES, Idaho Falls, ID (US); Birendra ADHIKARI, Idaho Falls, ID (US); Daniel Ernesto MOLINA MONTES DE OCA, Idaho Falls, ID (US)

(21) Appl. No.: 19/182,119

(22) Filed: Apr. 17, 2025

(51) Int. Cl. C25B 1/23; B01D 53/62; C25B 1/04; C25B 3/03; C25B 3/07; C25B 3/26; C25B 15/08

(52) U.S. Cl. CPC C25B 1/23; B01D 53/62; C25B 1/04; C25B 3/03; C25B 3/07; C25B 3/26; C25B 15/08; B01D 2257/504

(57) ABSTRACT

A method for producing syngas from an industrial CO₂-containing gas stream involves directing the gas stream and an aqueous capture solution stream to a membrane contactor to facilitate CO₂ transfer, producing a CO₂-lean gas stream and a CO₂-rich solution stream. The CO₂-rich solution stream is then directed to an electrochemical cell where CO₂ is reduced to CO and water is electrolyzed to produce H₂ and O₂, resulting in syngas (CO and H₂) and a CO₂-lean aqueous capture solution stream.

### STATEMENT REGARDING FEDERALLY SPONSORED RESEARCH OR DEVELOPMENT

The Government has rights in this invention pursuant to STRATEGIC PARTNERSHIP PROJECTS No. 22SP85 with Battelle Energy Alliance, LLC under Prime Contract NO. DE-AC07-05ID14517 with the U.S. Department of Energy.

### FIELD

The present disclosure relates to intensified CO₂ co-electrolysis (ICC) processes for producing synthesis gas (syngas).

### BACKGROUND

This section is intended to introduce the reader to some features of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Carbon capture, utilization, and storage (CCUS) is generally a process area intended to reduce the level of carbonaceous gases (most commonly carbon dioxide (CO₂)) within the atmosphere. This may include the capture of carbonaceous gases from sources of emissions so that they do not enter the atmosphere, which is commonly referred to as “point source capture.” Alternatively this may include directly removing the carbonaceous gases from the atmosphere, which is commonly referred to as “direct air capture.” In some instances, the captured gases may be used in other processes, such as in the production of new materials, chemicals, and so forth, or as a process gas. Alternatively, the captured carbonaceous gases may be stored (sequestered) in a variety of ways.

CCUS in general may afford an opportunity to enhance efficiencies for oil and gas or petroleum operations while also reducing carbon intensity of products. One such process intensifies the capture step with another one for its utilization. An example is provided here that concerns an intensified CO₂ co-electrolysis (ICC) process, which intensifies CO₂ capture and electrochemically converting the captured CO₂ into a product. Methods and systems to perform ICC continued to be studied and developed, as existing technologies are insufficient and thus subject to further improvement. What is needed are improved systems and methods for performing ICC.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Certain embodiments of this disclosure include a method for producing syngas (a gaseous mixture of CO and H₂) from an industrial CO₂-containing gas stream. The method may include directing the industrial CO₂-containing gas stream and an aqueous capture solution stream to a membrane contactor; facilitating CO₂ transfer from the industrial CO₂-containing gas stream to the aqueous capture solution stream using the membrane contactor to produce a CO₂-lean gas stream and a CO₂-rich solution stream. The CO₂-lean gas stream is lean in CO₂ relative to the CO₂-containing gas stream. The method may include directing the CO₂-rich solution stream to an electrochemical cell configured to electrochemically reduce CO₂ to CO at a cathode of the electrochemical cell and to electrolyze water to produce H₂ at the cathode and O₂ at an anode of the electrochemical cell such that a cathode outlet stream produced by the electrochemical cell comprises syngas and a CO₂-lean aqueous capture solution stream; and directing at least some of the CO₂-lean aqueous capture solution stream to the membrane contactor.

In another embodiment, the present disclosure includes a method of intensified carbon dioxide (CO₂) co-electrolysis (ICC) using an industrial CO₂-containing gas stream. The method includes directing the industrial CO₂-containing gas stream and an aqueous capture solution stream to a membrane contactor; facilitating CO₂ transfer from the industrial CO₂-containing gas stream to the aqueous capture solution stream using the membrane contactor to produce a CO₂-lean gas stream and a CO₂-rich solution stream, wherein the CO₂-lean gas stream is lean in CO₂ relative to the CO₂-containing gas stream; directing the CO₂-rich solution stream to an electrochemical cell configured to electrochemically reduce CO₂ at a cathode of the electrochemical cell and to electrolyze water to produce H₂ at the cathode and O₂ at an anode of the electrochemical cell such that a cathode outlet stream produced by the electrochemical cell comprises at least a CO₂ reduction product and a CO₂-lean aqueous capture solution stream; and directing at least some of the CO₂-lean aqueous capture solution stream to the membrane contactor.

### BRIEF DESCRIPTION OF THE DRAWINGS

Various embodiments of the present disclosure, together with further objects and advantages, may best be understood by reference to the following description taken in conjunction with the accompanying drawings, wherein:

FIG. 1 is a general process scheme of an intensified CO₂ co-electrolysis (ICC) system in which a CO₂ capture system is integrated with an electrochemical conversion system, in accordance with an embodiment of this disclosure;

FIG. 2 is an example of the ICC system of FIG. 1 including features for controlling CO₂ capture and syngas production, in accordance with an embodiment of this disclosure;

FIG. 3 is an example of an electrochemical cell used in the ICC systems of FIGS. 1 and 2, in accordance with an embodiment of this disclosure;

FIG. 4 is an example of an electrochemical cell used in the ICC systems of FIGS. 1 and 2, in accordance with an embodiment of this disclosure; and

FIG. 5 is an example of an electrochemical cell used in the ICC systems of FIGS. 1 and 2, in accordance with an embodiment of this disclosure.

### DETAILED DESCRIPTION

As set forth above, intensified CO₂ co-electrolysis (ICC) is a process that intensifies CO₂ capture with the electrochemical conversion of the captured CO₂ into a product, which in turn regenerates the capture media. The present disclosure relates to improved methods, systems, and electrocatalysts for performing ICC to produce electrochemical reaction products from the captured CO₂ and water of the CO₂ capture media. Synthesis gas “syngas” (a gaseous mixture of CO and H₂) is one such product.

### ICC System and Process

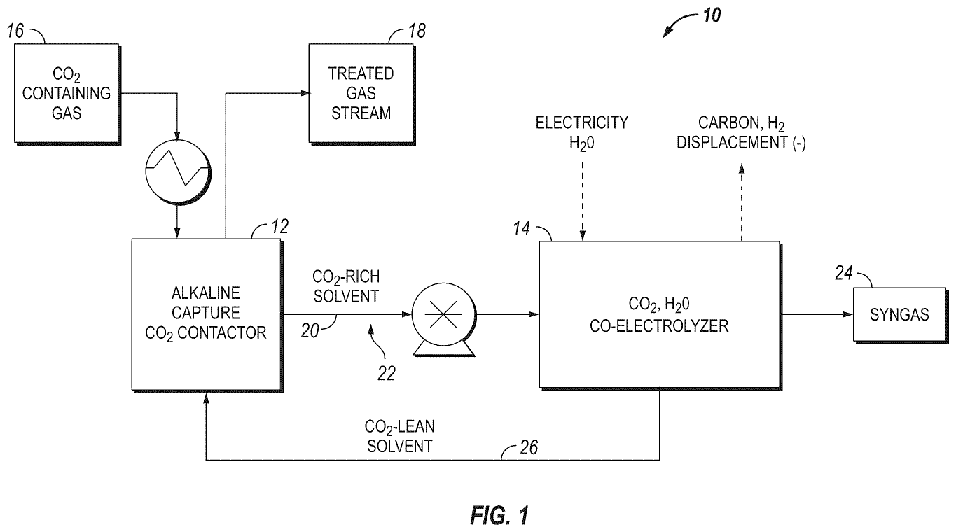

Present embodiments may be further appreciated with reference to FIG. 1, which is a general process scheme of an embodiment of an ICC system 10. In this embodiment, the ICC system 10 includes a CO₂ capture system 12 integrated with an electrochemical conversion system 14 by a flow system, which generally includes a variety of flow control equipment as discussed herein.

As discussed herein, the CO₂ capture system 12 is generally configured to capture CO₂ from an industrial CO₂-containing gas stream 16, such as a flue gas stream, to produce a treated gas stream 18 and a captured CO₂ stream 20. The ICC system 10 may receive virtually any CO₂-containing industrial gas such as flue gas, and therefore the ICC system 10 may be employed within most industrial settings in which flue gas is produced. For example, the industrial CO₂-containing gas stream 16 has between 0.5 vol % and 30 vol % CO₂, such as from 0.5 vol %, 1.0 vol %, 2.0 vol %, 3.0 vol %, or 4.0 vol % CO₂ up to 5.0 vol %, 8.0 vol %, 10 vol %, 15 vol %, 20 vol %, 25 vol %, or 30 vol % CO₂. In some embodiments, the ICC systems of this disclosure may find particular utility within petrochemical plants or power plants that are in need for reducing their CO₂ emissions and/or able to utilize the electrochemical reaction products (e.g., syngas) either as a fuel or as a feedstock for further chemical syntheses. The treated gas stream 18, which may be referred to as a CO₂-lean gas stream, produced by the CO₂ capture system 12 will generally have a lower CO₂ concentration than the industrial CO₂-containing gas stream 16. The captured CO₂ stream 20, which may be referred to as a CO₂-rich solution stream, will generally have a higher CO₂ concentration than the industrial CO₂-lean gas stream 18.

As described in further detail below, the CO₂ capture system 12 may use a liquid capture medium, such as an aqueous (e.g., alkaline) capture solution stream, to capture CO₂ from the industrial CO₂-containing gas stream 16. Therefore, the captured CO₂ stream 20 in such embodiments will be a CO₂-rich solution stream. The CO₂ capture system 12 may include any one or a combination of units configured to facilitate the taking up of CO₂ into the liquid capture medium. Such units may include, by way of non-limiting example, one or more gas-liquid contactors, such as one or more membrane contactors. A membrane gas contactor is preferred for advantageously providing a high contact surface area, occupying a small footprint while improving the transport of the CO₂ from the gas phase into the liquid phase.

In the illustrated embodiment, the captured CO₂ stream 20 follows along a captured CO₂ flow path 22 to the electrochemical conversion system 14. The captured CO₂ flow path 22 is intended to denote a path that the captured CO₂ follows through the ICC system 10, and may include one or more pipelines, vessels, heat exchangers, flow control equipment, and so forth, located between the CO₂ capture system 12 and the electrochemical conversion system 14. Depending on various configurations which may be utilized, the captured CO₂ in some embodiments may not remain in a capture solution through the entire captured CO₂ flow path 22.

The electrochemical conversion system 14 is configured to produce products resulting from one or more electrochemical processes, such as a syngas product 24 via electrochemical conversion of various materials in the captured CO₂ stream 20. As described in further detail below, the electrochemical conversions may include the electrochemical reduction of CO₂ to CO, and water electrolysis to produce O₂ and H₂. Depending on the materials and operating parameters of the electrochemical conversion system 14, other products may be produced in other embodiments, such as formate, methane, methanol, multi-carbon products, e.g., ethylene, ethanol, and so forth. The electrochemical conversion system 14 also produces a CO₂-lean capture solution stream 26, which may be returned to the CO₂ capture system 12 for further use as a capture medium.

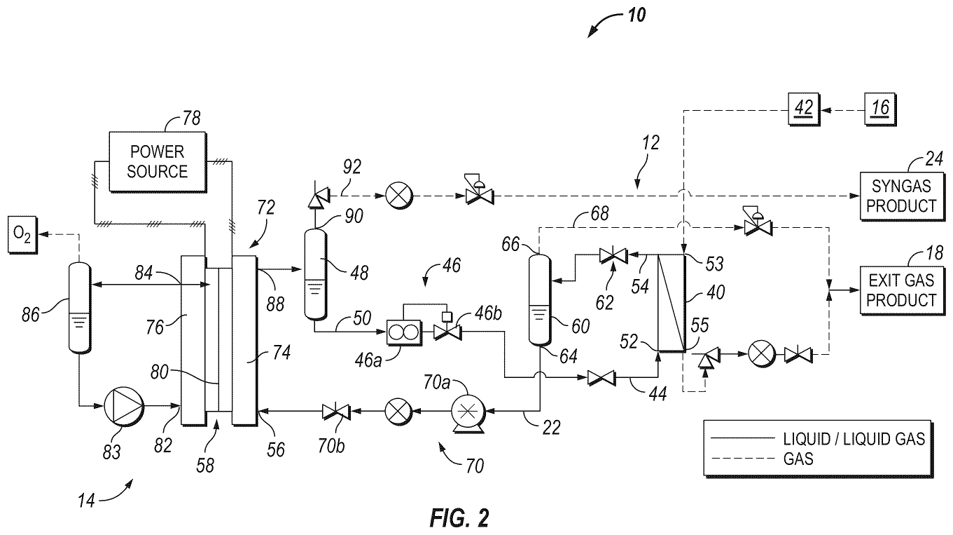

A more specific embodiment of the ICC system 10 is depicted in FIG. 2. In the illustrated embodiment of FIG. 2, the CO₂ capture system 12 includes a membrane contactor 40, which is coupled to a source of the industrial CO₂-containing gas 16 and a source of an aqueous capture solution stream. The membrane contactor 40 is generally configured to facilitate transfer of CO₂ from the industrial CO₂-containing gas stream and to the aqueous capture solution stream. The membrane contactor 40 has a configuration that allows the transfer of certain gases through pores of a membrane and into the aqueous capture solution stream-accomplished by a countercurrent flow and direct contact of the aqueous capture solution stream and the industrial CO₂-containing gas 16. The membrane pore size structure, the transmembrane pressure and temperature are key parameters to ensure an effective CO₂ transport from the gas phase to the liquid. Given the relative size of the CO₂ molecule the interplay among these parameters call for optimization to avoid bubble formation and/or to avoid blocking the CO₂ transport into the liquid phase entirely.

The membrane contactor 40 may include a plurality of porous membranes, a plurality of arrays such as hollow fibers, plate or frame membranes, or a combination thereof. Both membrane type and membrane array are selected in terms of the needs defined for the stream to be processed, e.g., CO₂ concentration in the stream and total volume to be processed. The membrane contactor may include a membrane array having a surface area (in m²) in the range of 1 to 3 times of each liter-unit of volume to CO₂-containing gas stream processed. Polypropylene, polytetrafluoroethylene (PTFE) and surface modified polyvinylidene fluoride (PVDF) are example membrane types that may be used in accordance with present embodiments. At lower CO₂ concentration in the stream and lower total volume to be processed, plate and/or frame configurations may be preferred while at higher values of either one hollow fiber configurations are preferred. In some embodiments, the membranes may be made of polypropylene in a microporous hollow fiber array hydrodynamically optimized for rapid and efficient gas transfer performance. An example membrane include those commercialized by 3M for use in their LIQUI-CEL™ EXF Series gas contactors. In some embodiments, at least 70% of the CO₂ from the industrial CO₂-containing gas 16 is transferred to the aqueous capture medium via the membrane contactor 40.

The flow system of this disclosure also includes a mass flow controller 42 that may be used to control the flow of the industrial CO₂-containing gas 16 into the membrane contactor 40. The mass flow controller 42 may include but is not limited to a thermal mass flow controller, a Coriolis mass flow controller, a differential pressure mass flow controller, an ultrasonic mass flow controller, an electromagnetic mass flow controller, or a turbine mass flow controller. The mass flow controller 42 will generally be situated between a source of the industrial CO₂-containing gas 16 and the membrane contactor 40 and may control the flow of the industrial CO₂-containing gas 16 to the membrane contactor 40 based on any one or a combination of factors including but not limited to: a rate of CO₂ capture by the aqueous capture medium; a rate of release of the CO₂ from the aqueous capture medium within the electrochemical conversion system 14; a rate of conversion of the released CO₂ within the electrochemical conversion system 14; a target ratio of CO to H₂ of the syngas 24; or others.

A flow of aqueous capture medium along capture medium flow path 44 to the membrane contactor 40 may be controlled by one or more flow control elements 46, which may include one or more pumps, flow meters, flow control valves, or a combination thereof. The one or more flow control elements 46 may be situated between the membrane contactor 40 and a source of the aqueous capture medium, which in the illustrated embodiment of FIG. 2 includes a gas-liquid separator 48. The gas-liquid separator 48 is described in further detail with respect to the electrochemical conversion system 14, and may in some embodiments be considered a product recovery unit. Other sources of the aqueous capture medium may be present, such as a storage tank, collection tank, and so forth, with associated flow controls for controlling aqueous capture medium flow to the membrane contactor 40. Indeed, in some embodiments, a pH adjustment system may be present to control the pH of the aqueous solution stream exiting liquid outlet of the gas-liquid separator 48 before the aqueous solution stream is provided to the liquid inlet of the membrane contactor 40.

In the illustrated embodiment, the flow control elements 46 include a flow meter 46a and a flow control valve 46b disposed along an aqueous capture medium flow path 50 extending from the gas-liquid separator 48 to a liquid inlet 52 of the membrane contactor 40. In embodiments where there is another source of the aqueous capture medium used as an alternative or in addition to the gas-liquid separator 48, the flow control elements 46 may include similar devices to the flow control meter 46a and flow control valve 46b.

In certain embodiments and as discussed in further detail below, the transfer rate of CO₂ from the CO₂-containing gas 16 into the aqueous capture medium may be synchronized with the production of CO within the electrochemical conversion system 14. In one embodiment, the synchronization is accomplished by balancing capture rate of the CO₂ by the aqueous capture solution stream with a rate of formation of a CO₂-lean aqueous capture solution produced by the electrochemical conversion system 14. The rate of capture of the CO₂ by the aqueous capture solution stream may be controlled, for instance, by among other things controlling the aqueous capture medium flow and the CO₂-containing gas 16 flow into the membrane contactor 40.

In accordance with present embodiments, the membrane contactor facilitates CO₂ transfer from the industrial CO₂-containing gas 16 to the aqueous capture solution stream to produce a CO₂-lean gas stream 18 and a CO₂-rich liquid solution stream, i.e., the CO₂ capture stream. The CO₂-lean gas stream is lean in CO₂ relative to the CO₂-containing gas 16. More specifically, the CO₂-containing gas 16 enters into the membrane contactor 40 via a gas inlet 53 situated at an opposite end from the liquid inlet 52 (for the aqueous capture medium). A liquid outlet 54 and gas outlet 55 are also situated at opposing ends of the membrane contactor 40, thereby encouraging a countercurrent flow of the aqueous capture medium and the CO₂-containing gas 16. The relative rates of these two flows may be controlled to target specific rates of CO₂ capture within the membrane contactor 40. The rate of CO₂ capture may also depend on the nature and concentration of the aqueous capture medium.

In accordance with embodiments of this disclosure, the aqueous capture medium used in the CO₂ capture system 12 is configured to preferentially capture CO₂ over other constituents that may be present in the CO₂-containing gas 16. For example the aqueous capture medium used in the CO₂ capture system 12 may be configured to preferentially capture CO₂ over other constituent gases present in refinery flue gas. Capture of the CO₂ may involve dissolution and/or reversible chemical conversion of the CO₂ by the aqueous capture medium. The aqueous capture medium is configured to bind the CO₂ in a way that does not hinder its electrolytic conversion within the electrochemical conversion system 14.

In some embodiments, the aqueous capture medium (aqueous capture solution stream) may be a basic solution, i.e., have an alkaline pH. The aqueous capture medium may include at least water and a base, and in certain embodiments may include one or more bases having either the same or different levels of basicity. The base may be a hydroxide base, a bicarbonate base, or other base. In accordance with some embodiments, the aqueous capture medium may be an aqueous alkali or alkaline earth metal hydroxide solution having a concentration ranging from 0.2M to 10M, such as from 0.2 M, 0.5 M, 1.0 M, 1.5 M, or 2.0 M up to 10 M, 9.0 M, 8.0 M, 7.0 M, 6.0 M, or 5.0 M. The concentration may depend on, among other things, the desired pH of the aqueous capture medium, the relative strength of the base used, and/or a target capture rate of CO₂. The pH of the aqueous capture medium may range between 7.5 and 12, such as from 7.5, 8, 8.5, or 9 to 12, 11.5, 11, 10.5, or 10. The pH of the aqueous capture medium may depend on any one or a combination of a target capture rate of CO₂, a rate at which CO₂ is used in the electrochemical conversion system 14, a rate at which CO₂ is released in the electrochemical conversion system 14, a rate at which CO is produced by the electrochemical conversion system 14, a gas-liquid contact surface area of the membrane contactor 40, or any combination thereof.

In accordance with certain embodiments, the aqueous capture solution may capture CO₂ via a chemical reaction that generates bicarbonate (HCO₃⁻), which is subsequently transformed back to CO₂ in a release reaction within the electrochemical conversion system 14. Non-limiting examples of the base used for the aqueous capture solution stream include any one or a combination of potassium hydroxide (KOH), sodium hydroxide (NaOH), lithium hydroxide (LiOH), magnesium hydroxide (Mg(OH)₂), calcium hydroxide (Ca(OH)₂), or barium hydroxide (Ba(OH)₂). In some embodiments, the captured CO₂ may be present in carbonate (CO₃²⁻) form, particularly at higher pH levels. The solvent (e.g., primary liquid phase) of the aqueous capture solution may be water (e.g., deionized water), or an amine, or a combination of water and amine. Example amines include 2-amino-2-methyl-1-propanol, cyclohexylpiperidine, dimethyl-cyclohexylamine, methyl-cyclohexylamine, methyldiethanolamine, monoethanolamine, tert-butylaminoethanol, tert-butylaminopropanol, and the like. Tertiary amines or alkanolamines in aqueous solution may be particularly useful since their interaction with CO₂ may result in the formation of bicarbonate/carbonate pairs, at suitable pKa of the amine.

As noted, the captured CO₂ stream 20 generated by the membrane contactor 40 exits via the outlet 54 and into the captured CO₂ flow path 22. Generally, the captured CO₂ stream 20 includes CO₂ in its captured form (e.g., as dissolved CO₂ and/or as bicarbonate and/or as carbonate), and aqueous capture medium. The captured CO₂ stream 20 may also be mixed with other gaseous components, including entrained but undissolved gases (e.g., undissolved CO₂ or gases that are components of the industrial CO₂-containing stream).

In the illustrated embodiment, the captured CO₂ flow path 22 extends from the outlet 54 to the electrochemical conversion system 14—specifically an electrochemical cell inlet 56 (e.g., a cathode inlet) of an electrochemical cell 58. Although only one electrochemical cell is illustrated in FIG. 2, the electrochemical conversion system 14 may include any number of electrochemical cells operating in series and/or parallel. In this way, one or more electrochemical cells may receive captured CO₂ from the captured CO₂ flow path 22. Thus, it may be beneficial to prepare the liquid-phase effluent from the membrane contactor 40 for delivery to the electrochemical conversion system 14, for example by ensuring the captured CO₂ stream 20 is at an appropriate flow rate, pressure, and has a reduced level of gaseous components that are not used in the electrochemical conversion system 14 (e.g., flue gas components other than CO₂).

To this end, various features may be disposed along the captured CO₂ flow path 22, including features configured to control flow of the captured CO₂ stream 20 and, in some embodiments, features to separate it from the undissolved/uncaptured gases. As depicted in FIG. 2, a second gas-liquid separator 60 is positioned between the liquid outlet 54 of the membrane contactor 40 and the electrochemical conversion system 14. The second gas-liquid separator 60 is configured to separate undissolved/uncaptured gases from the captured CO₂ stream 20. A valve 62 positioned between the outlet 54 and the second gas-liquid separator 60 is configured to control flow of the captured CO₂ stream 20 from the membrane contactor 40 to the second gas-liquid separator 60. The captured CO₂ stream 20 may also experience a pressure drop across the valve 62 which assists in the separation within the second gas-liquid separator 60. As shown in FIG. 2, the second gas-liquid separator 60 includes a bottoms outlet 64 for liquids, which allows discharge of the captured CO₂ stream 20 and an overhead outlet 66 which allows overhead withdrawal of removed gases 68.

Flow control equipment 70 positioned along the captured CO₂ flow path 22 configured to control a flow of the captured CO₂ stream 20 may include, as illustrated, a metering pump 70a and a flow control valve 70b though other flow control equipment may be used. As depicted, the captured CO₂ stream 20 is directed as an electrochemical cell feed into the inlet 56 at a cathode side 72 of the electrochemical cell 58.

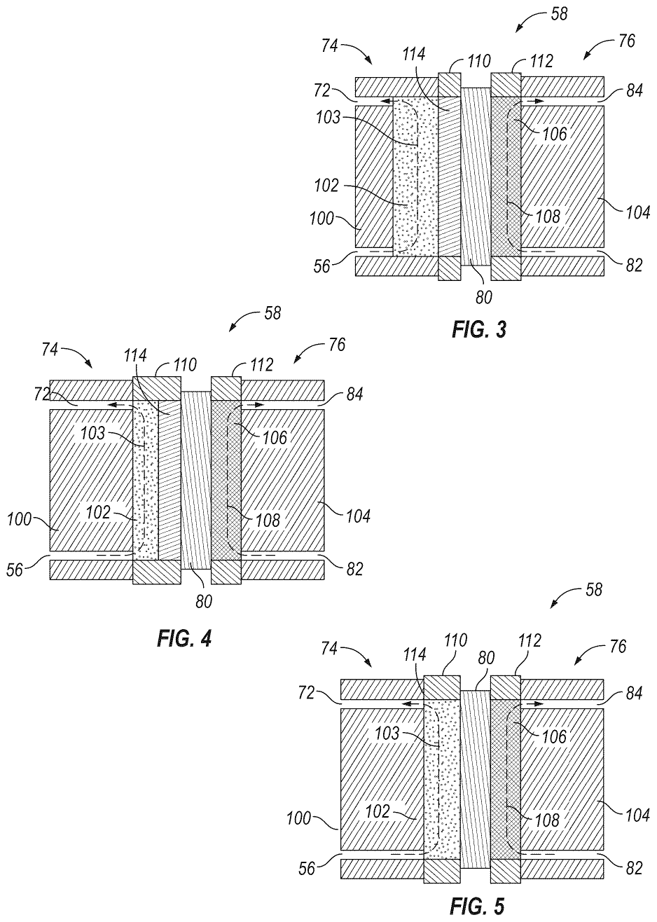

The electrochemical cell 58 is generally configured to perform co-electrolysis of water and CO₂. The co-electrolysis process of the electrochemical cell 58 produces CO, H₂, and O₂, although other compounds such as formate, methane, methanol, multi-carbon products, e.g., ethylene, ethanol, and so forth may be produced (e.g., as by-products or target products). More specifically, electrochemical half-reactions are performed within separate sections or compartments of the electrochemical cell 58: a cathode compartment 74 including a cathode (see, e.g., FIGS. 3-5) where reduction occurs and an anode compartment 76 including an anode (see, e.g., FIGS. 3-5) where oxidation occurs. A power source 78 allows electrons to flow from the anode compartment 76 to the cathode compartment 74 and controls current densities and voltages used for the electrochemical reactions within the anode compartment 76 and the cathode compartment 74.

As set forth above, CO₂ may be present in the captured CO₂ stream 20 as a dissolved gas and/or in another chemical form, such as bicarbonate (HCO₃⁻) or even carbonate (CO₃²⁻) in some situations. In the cathode compartment 74, HCO₃⁻ may release CO₂ and H₂O in the presence of protons (H+), which may be formed within the anode compartment 76. A membrane 80, such as a bipolar membrane or a cation exchange membrane, such as a proton exchange membrane (PEM), separates the cathode compartment 74 and the anode compartment 76, but allows for exchange of protons therebetween. In particular, in some embodiments the cathode compartment 74 may use protons for the conversion of CO₂ to CO and for the evolution of H₂. Moreover, the conversion of HCO₃⁻ to CO₂ and H₂O may also result in additional formation of hydrogen gas (H₂). The cathode compartment 74 may thus be a consumer of protons, thereby encouraging migration of protons produced within the anode compartment 76 across the membrane 80 to the cathode compartment 74.

Protons may be produced within the intermediate layer between anion exchange layer (AEM) and cation exchange layer (CEM) of a bipolar membrane where water is catalytically split to OH⁻ and H⁺ ions when about 0.8 V of potential difference is applied between the ionic layers. Protons may be also produced within the anode compartment 76 via the electrolytic oxidation of water (received at an anode inlet 82), where H₂O loses electrons to produce oxygen gas and protons. Anode flow control equipment 83, such as a pump, valve system, or a combination, is configured to control the flow of the water from a water source and to the anode inlet 82. The water source may include a tank or other equipment configured to produce a stream of water as discussed below. The anode inlet 82 may receive, for example, water, an alkaline solution, or an acidic solution.

An anode outlet 84 allows an anode outlet stream to exit the anode compartment 76. The anode outlet stream will generally include a mixture of at least water and the oxygen gas produced from the electrolytic oxidation of water. In certain embodiments, the system 10 may include a third gas-liquid separator 86 configured to separate gaseous components such as oxygen from water, which is provided via the anode inlet 82 to the anode compartment 76.

As depicted in the embodiment of FIG. 2, the cathode compartment 74 includes a cathode outlet 88 from which a cathode outlet stream exits the electrochemical cell 58. The cathode outlet stream generally includes syngas (CO and H₂) and a CO₂-lean aqueous capture solution stream 26. In other embodiments, the cathode compartment 74 may include multiple outlets, such as a gas outlet for gaseous components (e.g., syngas) and a liquid outlet for liquid components (e.g., the CO₂-lean aqueous capture solution stream 26). In such embodiments, the syngas may be separated from the CO₂-lean aqueous capture solution stream within the cathode compartment 74. However, in the embodiment of FIG. 2, this separation is performed by the gas-liquid separator 48 to separate the syngas product released from an overhead outlet 90 and into a syngas product flow path 92 from the CO₂-lean aqueous capture solution stream 26 delivered along the aqueous capture medium flow path 50.

As may be appreciated from the foregoing, the ICC system 10 may be operated to perform a method of intensified CO₂ co-electrolysis (ICC), for example a method of producing syngas from an industrial CO₂-containing gas stream (e.g., the stream 16). The method includes, for example, directing the industrial CO₂-containing gas stream and an aqueous capture solution stream to a membrane contactor, such as the membrane contactor 40.

The method may also include facilitating CO₂ transfer from the industrial CO₂-containing gas stream to the aqueous capture solution stream using the membrane contactor to produce a CO₂-lean gas stream and a CO₂-rich solution stream (e.g., the captured CO₂ stream 20). Due to the transfer of the CO₂ from the industrial CO₂-containing gas stream to the aqueous capture medium, the CO₂-lean gas stream is lean in CO₂ relative to the CO₂-containing gas stream. In accordance with an example embodiment of operating of the ICC system 10, the industrial CO₂-containing gas stream 16 and the aqueous capture solution are contacted in the membrane contactor 40 and the flowrate of feedstock and of the capture media are selected to provide a CO₂ capturing efficiency above 70%, such as between 70% and 99%, or between 75% and 95%. CO₂ capturing efficiency refers to the amount of CO₂ uptake into the aqueous capture solution stream from the industrial CO₂-containing gas stream, thus a capturing efficiency above 70% means that at least 70% of the CO₂ in in the industrial CO₂-containing gas stream is captured by the aqueous capture solution stream.

The method may also include directing the CO₂-rich solution stream to an electrochemical cell (e.g., the electrochemical cell 58) configured to electrochemically reduce CO₂ to CO at a cathode of the electrochemical cell and to electrolyze water to produce H₂ at the cathode and O₂ at an anode of the electrochemical cell such that a cathode outlet stream produced by the electrochemical cell comprises syngas (CO and H₂) and a CO₂-lean aqueous capture solution stream. As discussed, in certain embodiments, the cathode of the electrochemical cell may include more than one outlet such that there is a liquid-phase cathode outlet stream containing a CO₂-lean aqueous capture solution and a separate gas-phase cathode outlet stream containing syngas and potentially other gases.

As discussed, the ICC system 10 may include a variety of features for controlling flow rates, pressures, and types and amounts of materials flowing through the system to perform the method as described. Other features, such as the types of materials used (e.g., the aqueous capture medium, electrochemical cell materials), current densities and voltages from the power source 78, and various equipment selected may all affect the rates of CO₂ capture and syngas production within the ICC system 10. In accordance with the disclosed embodiments, the ICC system 10 described herein may be operated in a way that the production of syngas (e.g., the syngas product) is balanced with the uptake of CO₂ from the CO₂-containing gas 16. Generally, operation of the ICC system 10 involves balancing four steps including CO₂ capture, CO₂ release, CO₂ conversion, and media recycling.

In some embodiments, these four steps may be interrelated in the ICC system 10 at least as follows: CO₂ capture may be affected by the pH of the aqueous capture solution when the CO₂ and solution are contacted within the membrane contactor 40, as well as the surface area of their contact and the rates at which they are provided to the membrane contactor 40. CO₂ release may depend on the availability of ions (e.g., protons) for converting bicarbonate or carbonate back to CO₂, the localized pH within the cathode compartment 74, and conversion rates of CO₂ to CO by the cathode of the cathode compartment 74. In some embodiments and by way of example, the aqueous capture solution stream releases CO₂ at the cathode at a rate of at least 0.01 mmol/min·cm² at a current density of 200 mA/cm². In one example embodiment, the aqueous capture solution stream releases CO₂ at the cathode at a rate of between 0.01 mmol/min·cm² and 0.05 mmol/min·cm² at a current density of 200 mA/cm². As may be appreciated, these values depend on the conversion of CO₂ to CO, which reduces a local concentration of CO₂ and helps to drive further CO₂ release via the reversible chemical transformation of bicarbonate or carbonate to CO₂.

The CO₂ conversion may depend on the quantity of CO₂ available for electrochemical reduction within the cathode compartment 74 (e.g., based on pH), the electrochemical and electrocatalytic activity of the cathode, the availability of protons from the anode, and the current density applied from the power source 78. Once the CO₂ is converted, the now CO₂ lean aqueous capture solution is available to capture more CO₂, and thus the capture medium recycling process depends at least in part on the foregoing steps.

In certain embodiments, it has been found that the high surface area provided by the membrane contactor 40 (high relative to other types of gas-liquid contactors) also enables a steady operation from subtle pH swings caused by the electrochemical and CO₂ capture reactions in carbonate/bicarbonate solutions. The cathode outlet stream leaving the cathode compartment 74, for instance, reaches a first pH (e.g., pH>9) because of the OH⁻ ions generated during CO₂ reduction and/or hydrogen evolution. This solution (the cathode outlet stream) is separated from gaseous components and is subsequently fed as the aqueous capture solution stream to the membrane contactor 40 where the CO₂ capture reduces the pH of the aqueous capture solution to a second, lower pH (e.g., pH<8.5) that is selected for desired levels of CO₂ release and conversion at the electrochemical cell 58.

In this regard, in certain embodiments it may be beneficial to maintain the pH shift between the aqueous capture solution stream at cathode outlet 88 (out of the cathode compartment 74) and the captured CO₂ stream 20 to within a certain range. That is, too small of a pH shift or too large of a pH shift may result in inefficient uptake and/or inefficient release of CO₂ at the desired sections of the ICC system 10. As an example, in accordance with certain embodiments a pH shift between the aqueous capture solution stream and the captured CO₂ stream 20 may be maintained between 0.5 and 2, such as between 0.8 and 1.8, or between 0.9 and 1.5. The pH shift may be one in which the pH of the aqueous capture stream is higher than the pH of the captured CO₂ stream 20—that is, the pH of the aqueous capture stream may be between 0.5 and 2 higher than the pH of the captured CO₂ stream 20.

In certain embodiments, the transfer rate of the CO₂ from the industrial CO₂-containing gas stream 16 to the aqueous capture solution stream using the membrane contactor 40 is synchronized with the production of CO within the cathode compartment 74. Such synchronization may be desirable to enable a continuous ICC process. This may be accomplished, by way of example, by balancing the capture of the CO₂ by the aqueous capture solution stream with a rate of formation of the CO₂-lean aqueous capture solution. Formation of the CO₂-lean aqueous capture solution may be monitored for example by various equipment situated at or proximate the cathode outlet 88, at or proximate the liquid outlet of the gas-liquid separator 48, using the flow control equipment 46 situated along the aqueous capture medium flow path 50, or any combination thereof. pH may also be used as an indicator of OH⁻ ion production and therefore may be used in some situations as an indirect indicator of CO production. Otherwise, CO production could be monitored by sensing CO concentration of the gas phase flow of the cathode outlet stream.

In an example embodiment, the electrochemical cell 58 (which may also be referred to as an electrolyzer) is operated at a voltage in the range of 1-6 V, under current densities above 150 mAmp/cm². Given a particular selection of electrochemical cell materials within the electrochemical cell 58, this may sustain a steady conversion of CO₂ above 70%, which balances with the rate of CO₂ capture within the membrane contactor 40 of at least 70%. As noted above, syngas is recovered at a cathode outlet, and the syngas may be present together with a small fraction of unconverted CO₂ gas, typically below 10 vol %. Oxygen, as noted, is collected as the gas product of the anode.

### Electrochemical Cell

The specific configuration of the electrochemical cell 58 may vary, with example embodiments shown in FIGS. 3-5 and discussed in further detail below. In each of the configurations shown in FIGS. 3-5, the electrochemical cell 58 includes the cathode compartment 74 and the anode compartment 76 separated by the membrane 80.

Each cathode compartment 74 includes a cathode current collector 100 (e.g., a titanium (Ti) current collector plate) and a porous cathode 102. The specific configuration, chemistry, and method of making the cathode 102 are discussed in further detail herein. The cathode compartment 74, as noted above, includes the cathode inlet 56 and the cathode outlet 72. As depicted, a catholyte, such as the captured CO₂ stream 20, may move through the porous cathode 102 in a direction 103 (e.g., a catholyte flow path) from the inlet 56 toward the outlet 72. The porous nature of the porous cathode 102 allows for enhanced surface area and interaction between the CO₂ in the captured CO₂ stream 20 and an electrocatalyst of the porous cathode 102.

Each anode compartment 76 includes an anode current collector 104 (e.g., a titanium (Ti) current collector plate) and a porous anode 106 which may be for example a nickel (Ni)-based anode or other appropriate counter electrode for the cathode 102. The anode compartment 76, as discussed, includes the anode inlet 82 and the anode outlet 84. As depicted, an anolyte, for example water, an acid solution (e.g., H₂SO₄ solution) or an alkaline solution (e.g., KOH solution), may move through the porous anode 106 in a direction 108 (e.g., an anolyte flow path) from the inlet 82 toward the outlet 84 to produce protons (H⁺) and oxygen (O₂). Although not shown, the power source 78 may apply a voltage between the cathode current collector 100 and the anode current collector 104 to drive the electrochemical reactions in the cathode compartment 74 and in the anode compartment 76.

To encourage movement of the materials through the electrochemical cell 58, the cell may be pressurized. Indeed, in certain embodiments the cathode compartment 74 and the anode compartment 76 may have different pressures to control the movement of ions and other substances across the membrane 80. In one embodiment, the cathode compartment 74 may be operated at a higher pressure than the anode compartment 76 to discourage crossover of material. By way of non-limiting example, the pressure in the cathode compartment 74 may be between 5% and 30% higher than the pressure in the anode compartment 76. These pressures may be controlled, for example, by the flow control equipment 70 for the cathode compartment 74 and flow control equipment 83 for the anode compartment 76.

The electrochemical cell 58 as shown in FIGS. 3-5 may include one or more cathode gaskets 110 and one or more anode gaskets 112 to allow for pressurization of the cathode compartment 74 and the anode compartment 76, respectively. The cathode gasket 110 and anode gasket 112 also seal off and assist in defining flow patterns for the catholyte and anolyte, and facilitate mass transfer within the electrochemical cell 58.

The anode gasket 112 in the depicted embodiments generally fits about a perimeter of the anode 106 and seals against the membrane 80 and the anode current collector 104. The cathode gasket 110 of the embodiments of FIGS. 3-5 seals against the membrane 80 and the cathode current collector 100. However, the cathode gasket 110 may fit about different features of the cathode compartment 74 as may be appreciated with reference to the different configurations of FIGS. 3-5.

In particular, FIG. 3 depicts an example embodiment of the electrochemical cell 58 having a thick cathode gap configuration. In the configuration shown in FIG. 3, the cathode 102 is much thicker compared to the anode 106 (as measured in a direction running from the cathode current collector 100 toward the anode current collector 104) and a separator 114 is positioned between the membrane 80 and the cathode 102. In addition, the cathode current collector 100 is thinner (as measured in a direction running from the cathode current collector 100 toward the anode current collector 104) compared to the anode current collector 104. The separator 114 (e.g., an inert porous layer) may be made of a polyester material in some embodiments. In this configuration, the cathode gasket 110 is situated about the perimeter of the separator 114.

In the configuration of FIG. 4, the separator 114 is again situated between the membrane 80 and the cathode 102. In contrast to the embodiment of FIG. 3, the cathode 102 is approximately the same thickness as the anode 106, and the cathode gasket 110 is positioned about the perimeter of both the cathode 102 and the separator 114.

The electrochemical cell configuration of FIG. 5 is considered a zero-gap configuration, having or not a separator used in this embodiment. In such embodiments, a separator is used as a mass transport vehicle at a reduced distance between the cathode 102 and the anode 106 to enhance efficiency. Efficiency increases may result from reduced resistance between the cathode 102 and the anode 106 and enhanced ion transport between them with a better distribution of electrolyte throughout the compartments.

In accordance with certain embodiments of this disclosure, the cathode 102 as depicted in FIGS. 3-5 may be considered to represent an electrocatalyst configured to promote reductive water electrolysis and the reductive transformation of CO₂ (e.g., to CO). The electrocatalyst of the present disclosure may have an appropriate selectivity and conversion for the simultaneous reactions of carbon dioxide reduction and hydrogen evolution. By way of non-limiting example, the electrocatalyst may include silver, nickel, copper, gold, palladium, or any combination thereof.

The specific embodiments described above have been shown by way of example, and it should be understood that these embodiments may be susceptible to various modifications and alternative forms and can also be used in any appropriate combination. It should be further understood that the claims are not intended to be limited to the particular forms disclosed, but rather to cover all modifications, equivalents, and alternatives falling within the spirit and scope of this disclosure.

What is claimed is:

1. A method of producing syngas (H₂ and CO) from an industrial CO₂-containing gas stream comprising:
directing the industrial CO₂-containing gas stream and an aqueous capture solution stream to a membrane contactor;
facilitating CO₂ transfer from the industrial CO₂-containing gas stream to the aqueous capture solution stream using the membrane contactor to produce a CO₂-lean gas stream and a CO₂-rich solution stream, wherein the CO₂-lean gas stream is lean in CO₂ relative to the CO₂-containing gas stream;
directing the CO₂-rich solution stream to an electrochemical cell configured to electrochemically reduce CO₂ to CO at a cathode of the electrochemical cell and to electrolyze water to produce H₂ at the cathode and O₂ at an anode of the electrochemical cell such that a cathode outlet stream produced by the electrochemical cell comprises syngas (CO and H₂) and a CO₂-lean aqueous capture solution stream; and
directing at least some of the CO₂-lean aqueous capture solution stream to the membrane contactor.

2. The method of claim 1, wherein a pH shift between the CO₂-rich solution stream and the cathode outlet stream is between 0.5 and 2.

3. The method of claim 2, wherein a pH of the aqueous capture solution stream is higher than a pH of the CO₂-rich solution stream.

4. The method of claim 3, wherein the pH of the aqueous capture solution stream is between 7.5 and 12.

5. The method of claim 1, wherein transfer rate of the CO₂ from the industrial CO₂-containing gas stream to the aqueous capture solution stream using the membrane contactor is synchronized with the rate of production of CO at the cathode.

6. The method of claim 5, wherein the synchronization is accomplished by balancing capture of the CO₂ by the aqueous capture solution stream with a rate of formation of the CO₂-lean aqueous capture solution.

7. The method of claim 1, comprising directing the cathode outlet stream to a gas-liquid separator to separate syngas from the CO₂-lean aqueous capture solution stream, and directing the CO₂-lean aqueous capture solution stream to the membrane contactor.

8. The method of claim 1, wherein the industrial CO₂-containing gas has between 0.5 vol % and 30 vol % CO₂.

9. The method of claim 1, wherein the aqueous capture solution stream is configured to bind the CO₂ in a way that does not hinder its electrolytic reduction at the cathode.

10. The method of claim 9, wherein the aqueous capture solution stream consists of a solution of an alkaline or an alkaline earth hydroxide, at a concentration ranging from 0.2M to 10M.

11. The method of claim 1, wherein at least 70% of the CO₂ from the industrial CO₂-containing gas stream is transferred to the aqueous capture solution stream via the membrane contactor.

12. The method of claim 1, wherein the aqueous capture solution stream releases CO₂ at the cathode at a rate of at least 0.01 mmol/min·cm² at a current density of 200 mA/cm².

13. The method of claim 1, wherein the aqueous capture solution stream releases CO₂ at the cathode at a rate of between 0.01 mmol/min·cm² and 0.05 mmol/min·cm² at a current density of 200 mA/cm².

14. A method of intensified carbon dioxide (CO₂) co-electrolysis (ICC) using an industrial CO₂-containing gas stream, the method comprising:
directing the industrial CO₂-containing gas stream and an aqueous capture solution stream to a membrane contactor;
facilitating CO₂ transfer from the industrial CO₂-containing gas stream to the aqueous capture solution stream using the membrane contactor to produce a CO₂-lean gas stream and a CO₂-rich solution stream, wherein the CO₂-lean gas stream is lean in CO₂ relative to the CO₂-containing gas stream;
directing the CO₂-rich solution stream to an electrochemical cell configured to electrochemically reduce CO₂ at a cathode of the electrochemical cell and to electrolyze water to produce H₂ at the cathode and O₂ at an anode of the electrochemical cell such that a cathode outlet stream produced by the electrochemical cell comprises at least a CO₂ reduction product and a CO₂-lean aqueous capture solution stream; and
directing at least some of the CO₂-lean aqueous capture solution stream to the membrane contactor.

15. The method of claim 14, wherein the CO₂ reduction product comprises CO, or formate, or methane, or methanol, or a combination thereof.

16. The method of claim 14, wherein the CO₂ reduction product comprises a multi-carbon product.

17. The method of claim 14, wherein the CO₂ reduction product comprises ethylene or ethanol, or a combination thereof.
